(19) United States
(12) Patent Application Publication
(10) Pub. No.: US 2018/0326354 A1
(43) Pub. Date: Nov. 15, 2018

(54) IMPROVED PROCESS FOR REMOVING NOX FROM EXHAUST GAS

(71) Applicant: SHELL OIL COMPANY, HOUSTON, TX (US)

(72) Inventors: Marinus Franciscus GOES, Assen (NL); Bradley Douglas MORELLO, Houston, TX (US)

(21) Appl. No.: 15/776,578

(22) PCT Filed: Nov. 16, 2016
(86) PCT No.: PCT/EP2016/077904

§ 371 Date: May 16, 2018

(30) Foreign Application Priority Data
Nov. 18, 2015 (EP) 15195220.7

(51) Int. Cl. B01D 53/86; B01J 23/30; B01J 23/28; B01D 53/94

(52) U.S. Cl. CPC B01D 53/8628; B01J 23/30; B01J 23/28; B01D 2251/2062; B01D 53/9427; B01D 2255/20738; B01D 53/9495

(57) ABSTRACT

The present invention provides a process for the treatment of a NO_{X}-containing gas stream, said NO_{X}-containing gas stream containing NO2 and NO in a molar ratio of NO₂:NO of at least 1:1, to remove at least a portion of the NO_{X} contained therein, said process comprising: i) providing an additional gas stream comprising NO to the NO_{X}-containing gas stream, such that the molar ratio of NO₂:NO in the NO_{X}-containing gas stream is reduced to be less than 1:1; and ii) then passing the NO_{X}-containing gas stream through a catalyst bed comprising a deNO_{X} catalyst under suitable conditions to reduce the level of NO_{X} in the gas stream and thus produce a deNO_{X} treated gas stream, said deNO_{X} treated gas stream containing a reduced amount of NO_{X}.

### FIELD OF THE INVENTION

The invention relates to an improved process for the removal of NO_{X} from exhaust gases.

### BACKGROUND OF THE INVENTION

Oxides of nitrogen are common by-products and/or desirable intermediates in a number of industrial processes, including the manufacture of chemicals, such as nitric acid, or combustion processes in air. Nitrogen oxides of the formula NO and NO₂ are typically referred to together as NO_{X}. NO_{X} is a large scale pollutant and significant efforts have been made for the reduction of NO_{X} in exhaust gas streams from processes in which they are produced. Processes for removal of NO_{X} from gas streams are generally referred to in the art as DeNO_{X} processes and the catalysts used therein as DeNO_{X} catalysts.

One process used for the removal of NOₓ from gas streams is the selective catalytic reduction (SCR) process. One version of this process is disclosed in U.S. Pat. No. 7,294,321. In this selective catalytic reduction process, a combustion gas that contains a concentration of NOₓ and ammonia (NH₃), which is typically added to the combustion gas as a reactant, is contacted with a catalyst that promotes the reduction reaction in which the NOₓ reacts with ammonia and oxygen to yield nitrogen and water.

Nitrous oxide (N₂O) is a greenhouse gas and is considered to be a greater contributor to climate change by weight than carbon dioxide. In many countries limits on nitrous oxide emissions have been set and efforts have been focussed on developing methods to remove nitrous oxide from exhaust gases. Many of these efforts have focussed on identifying catalysts suitable for use in the catalytic decomposition of nitrous oxides. Processes for removal of N₂O from gas streams are generally referred to in the art as DeN₂O processes and the catalysts used therein as DeN₂O catalysts.

Zeolite-supported iron catalysts, optionally also containing a noble metal such as Pt or Ru, have been described, for example in U.S. Pat. No. 5,171,553, WO2005110582 and Journal of Catalysis 243 (2006), 340-349. Other known nitrous oxide decomposition catalysts include those based on base metal oxides such as Co₃O₄, as described in U.S. Pat. No. 5,705,136 and Catalysis Communications 4 (2003) 505-509. A bulk metal oxide catalyst for the removal of nitrous oxide from waste gas is described in WO2015014863.

It is considered advantageous to be able to treat a gas stream containing both NO_{X} and N₂O in order to reduce the amounts of both NO_{X} and minimise N₂O in the treated gas stream. This may be carried out by subjecting said gas stream to a DeN₂O process in the presence of a DeN₂O catalyst and then subjecting the resultant stream to a DeNO_{X} process in the presence of a DeNO_{X} catalyst.

However, competing reactions occur in these processes which may reduce their efficiency in producing a treated stream low in both NO_{X} and N₂O. For example, treatment of a NO_{X}-containing stream which is NO₂-rich (containing more NO₂ than NO on a molar basis) over a DeNO_{X} catalyst may result in the formation of N₂O.

It would be desirable to provide a robust process for the reduction of NO_{X} from NO_{X}-containing streams, in which the level of N₂O in the treated stream is also minimised.

### SUMMARY OF THE INVENTION

Accordingly, the present invention provides a process for the treatment of a NO_{X}-containing gas stream, said NO_{X}-containing gas stream containing NO₂ and NO in a molar ratio of NO₂:NO of at least 1:1, to remove at least a portion of the NO_{X} contained therein, said process comprising:

i) providing an additional gas stream comprising NO to the NO_{X}-containing gas stream, such that the molar ratio of NO₂:NO in the NO_{X}-containing gas stream is reduced to be less than 1:1; and
ii) then passing the NO_{X}-containing gas stream through a catalyst bed comprising a deNO_{X} catalyst under suitable conditions to reduce the level of NO_{X} in the gas stream and thus produce a deNO_{X} treated gas stream, said deNO_{X} treated gas stream containing a reduced amount of NO_{X}.

The present invention also provides a process for the treatment of a N₂O- and NO_{X}-containing gas stream to remove at least a portion of each of the NO_{X} and the N₂O contained therein, said process comprising:

i) passing the N₂O- and NO_{X}-containing gas stream through a catalyst bed comprising a deN₂O catalyst under suitable conditions to reduce the level of N₂O in said N₂O- and NO_{X}-containing gas stream and thus produce a deN₂O-treated gas stream, said deN₂O-treated gas stream containing a reduced amount of N₂O;
ii) taking at least a portion of said deN₂O-treated gas stream to provide a NO_{X}-containing gas stream; and
iii) passing at least a portion of said NO_{X}-containing gas stream through a catalyst bed comprising a deNO_{X} catalyst under suitable conditions to reduce the level of NO_{X} in the deN₂O-treated gas stream and thus produce a deNO_{X}-treated gas stream, said deNO_{X}-treated gas stream containing a reduced amount of NO_{X};
wherein an additional gas stream comprising NO is provided to either or both of the N₂O- and NO_{X}-containing gas stream and the NO_{X}-containing gas stream, such that the ratio of NO₂:NO in the NO_{X}-containing gas stream is less than 1:1.

### BRIEF DESCRIPTION OF THE DRAWINGS

FIGS. 1 and 2 are representations of exemplary, but non-limiting embodiments of the invention.

### DETAILED DESCRIPTION OF THE INVENTION

The present inventors have surprisingly found that by decreasing the ratio of NO₂:NO in a NO_{X}-containing gas stream before subjecting it to treatment with a deNO_{X} catalyst, the overall level of pollutants in the resultant deNO_{X} treated gas stream, in the form of oxides of nitrogen, can be decreased.

The NO_{X}-containing gas stream in the process of the invention may be any gas stream containing NO_{X}. Preferably, the NO_{X}-containing gas stream is derived from an exhaust gas stream, typically from an industrial process. Exhaust gas streams particularly suitable for use as the NO_{X}-containing gas stream in the process of the present invention include exhaust gas streams from a process for the production of nitric acid.

Typically the NO₂ content of the NO_{X}-containing gas stream is in the range of from 500 to 10000 ppmv.

Typically the NO content of the NO_{X}-containing gas stream is in the range of from 500 to 10000 ppmv.

When using the process of the invention, the ratio of NO₂:NO in the NO_{X}-containing gas stream, before the introduction of the additional gas stream comprising NO is at least 1:1, preferably greater than 1:1.

The NO_{X}-containing gas stream is contacted with a catalyst bed comprising a deNO_{X} catalyst under suitable conditions to reduce the level of NO_{X} in said NO_{X}-containing gas stream and thus produce a deNO_{X} treated gas stream.

Any deNO_{X} catalysts may suitably be used in the process of the present invention, for example those described in U.S. Pat. No. 6,419,889. An exemplary catalyst from U.S. Pat. No. 6,419,889 comprises a titania carrier and one or more metal compounds which metals are selected from the group consisting of vanadium, molybdenum and tungsten. Said catalyst typically has a surface area measured by nitrogen adsorption of between about 70 m²/g and about 99 m²/g. Said catalyst suitably has a bimodal pore distribution with more than 90% of the pore volume present in pores having a diameter of at most about 100 nm, which pore volume is considered to be the pore volume present in pores having a diameter between about 1 nm and about 10⁴ nm. Further, said catalyst is obtainable by impregnating or deposition of the carrier with the metal compound(s) after extruding, drying and calcining the carrier.

Suitable conditions to reduce the level of NO_{X} in the gas stream include a pressure in the range of from 0 kPa (gauge) to 1200 kPa (gauge) and a temperature in the range of from 140° C. to 400° C.

The deNO_{X} treated gas stream will contain a reduced level of NO_{X} (considering both NO and NO₂ on a molar basis) compared to the NO_{X}-containing gas stream. Preferably, the deNO_{X} treated gas stream contains no more than 10% of the amount of NO_{X} in the NO_{X}-containing gas stream. More preferably, the deNO_{X} treated gas stream contains no more than 5% of the amount of NO_{X} in the NO_{X}-containing gas stream. Even more preferably, the deNO_{X} treated gas stream contains no more than 2% of the amount of NO_{X} in the NO_{X}-containing gas stream. Most preferably, the deNO_{X} treated gas stream contains no more than 1% of the amount of NO_{X} in the NO_{X}-containing gas stream.

In a preferred embodiment of the invention, the NO_{X}-containing gas stream is derived from a N₂O- and NO_{X}-containing gas stream. In said embodiment, the N₂O- and NO_{X}-containing gas stream in the process of the invention may be any gas stream containing N₂O and NO_{X}. Preferably, the N₂O- and NO_{X}-containing gas stream is an exhaust gas stream, typically from an industrial process. Exhaust gas streams particularly suitable for use as the N₂O- and NO_{X}-containing gas stream in the process of the present invention include exhaust gas streams from a process for the production of nitric acid.

In this embodiment, depending on the exhaust stream, the amount of N₂O present will vary. For the exhaust stream from a nitric acid plant, typically the N₂O content of the N₂O- and NO_{X}-containing gas stream is in the range of from 500 to 10000 ppmv, preferably in the range of from 500 to 2000 ppmv.

Further, in this embodiment, prior to the NO_{X}-containing gas stream being passed through a catalyst bed comprising a deNO_{X} catalyst under suitable conditions to reduce the level of NO_{X} in the gas stream, the N₂O- and NO_{X}-containing gas stream is passed through a catalyst bed comprising a deN₂O catalyst under suitable conditions to reduce the level of N₂O in said N₂O- and NO_{X}-containing gas stream and, thus, produce a deN₂O-treated gas stream, said deN₂O-treated stream containing a reduced amount of N₂O. At least of portion of said deN₂O-treated gas stream is then used as the NO_{X}-containing gas stream.

When using the process of the invention, the molar ratio of NO2:NO in the N₂O- and NO_{X}-containing gas stream, before any introduction of the additional gas stream comprising NO is typically at least 1:1, preferably greater than 1:1. However, in some embodiments in which the deN₂O catalyst converts some NO to NO₂, the ratio of NO₂:NO in the N₂O- and NO_{X}-containing gas stream, before any introduction of the additional gas stream may be lower than this.

Other gases present in the NO_{X}-containing and/or N₂O- and NO_{X}-containing gas stream, wherein the said gas stream or streams are derived from the exhaust stream from a nitric acid plant include, but are not limited to, nitrogen, H₂O, oxygen and argon.

In the process of the present invention, a N₂O- and NO_{X}-containing gas stream may initially be passed through a catalyst bed comprising a deN₂O catalyst under suitable conditions to reduce the level of N₂O in the gas stream and thus produce a deN₂O-treated gas stream, said deN₂O-treated gas stream containing a reduced amount of N₂O.

Any deN₂O catalysts may suitably be used in the process of the present invention, including base metal catalyst and zeolite-supported iron catalysts, optionally also containing a noble metal such as Pt or Ru. Such zeolite-supported iron catalysts include those described in U.S. Pat. No. 5,171,553, WO2005110582 and Journal of Catalysis 243 (2006), 340-349. Suitable base metal catalyst have been described in U.S. Pat. No. 5,705,136, Catalysis Communications 4 (2003) 505-509 and WO2015014863.

Suitable conditions to reduce the level of N₂O in the gas stream include a pressure in the range of from 0 kPa (gauge) to 1200 kPa (gauge) and a temperature in the range of from 350° C. to 650° C.

The deN₂O-treated gas stream contains a reduced amount of N₂O. Preferably, the deN₂O-treated gas stream contains no more than 10% of the amount of N₂O in the N₂O- and NO_{X}-containing gas stream. More preferably the deN₂O-treated gas stream contains no more than 5% of the amount of N₂O in the N₂O- and NO_{X}-containing gas stream. Even more preferably, the deN₂O-treated gas stream contains no more than 2% of the amount of N₂O in the N₂O- and NO_{X}-containing gas stream. Most preferably, the deN₂O-treated gas stream contains no more than 1% of the amount of N₂O in the N₂O- and NO_{X}-containing gas stream.

In the process of the present invention, an additional gas stream comprising NO is provided to either or both of (i) the NO_{X}-containing gas stream before it is contacted with the deNO_{X} catalyst and (ii) the N₂O- and NO_{X}-containing gas stream before it is contacted with the deN₂O catalyst in the embodiment wherein a N₂O- and NO_{X}-containing gas stream is treated with a deN₂O catalyst in order to form a deN₂O-treated gas stream, at least a portion of which is used as the NO_{X}-containing gas stream. This additional gas stream contains NO in such an amount and concentration that the resultant ratio of NO₂:NO in the NO_{X}-containing gas stream is less than 1:1, preferably no more than 0.8:1.

Preferably the additional gas stream comprising NO is another process gas stream produced in the process which produces either the NO_{X}-containing or the N₂O- and NO_{X}-containing gas streams. In one particularly preferred embodiment, the NO_{X}-containing or the N₂O- and NO_{X}-containing gas stream is an exhaust gas stream from an industrial process and the additional gas stream is another gas stream within that process. Most preferably, the NO_{X}-containing or the N₂O- and NO_{X}-containing gas stream is an exhaust gas stream from a nitric acid plant and the additional gas stream is formed from at least a portion of an outlet stream from the ammonia burner in such a process.

### DETAILED DESCRIPTION OF THE DRAWINGS

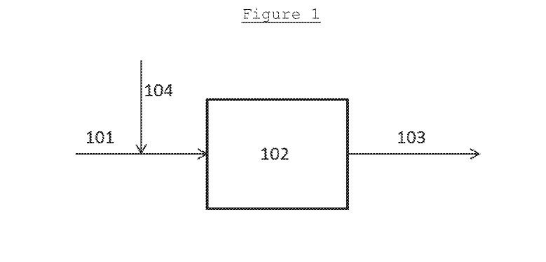

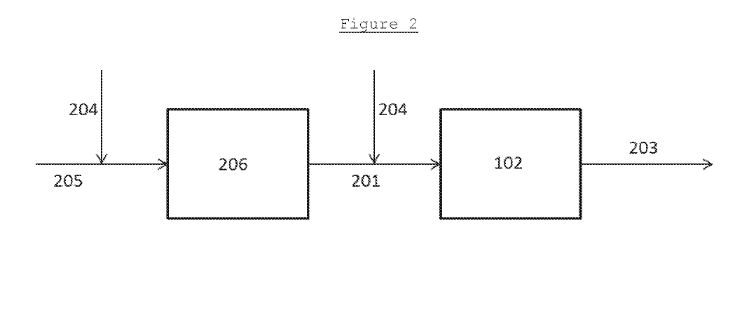

The present invention is further illustrated in the preferred, but non-limiting, embodiments of the invention illustrated in FIGS. 1 and 2. In these Figures, the first digit of each reference number refers to the Figure number (i.e. 1XX for FIGS. 1 and 2XX for FIG. 2). The remaining digits refer to the individual features and the same features are provided with the same number in each Figure. Therefore, the same feature is numbered 104 in FIGS. 1 and 204 in FIG. 2.

In FIG. 1, a NO_{X}-containing gas stream 101 is passed through a catalyst bed 102 comprising a deNO_{X} catalyst under suitable conditions to reduce the level of NO_{X} in the gas stream and thus produce a deNO_{X} treated gas stream 103, said deNO_{X} treated gas stream containing a reduced amount of NO_{X}. An additional gas stream 104 comprising NO is provided to the NO_{X}-containing gas stream, such that the ratio of NO₂:NO in the NO_{X}-containing gas stream is no more than 1:1.

FIG. 2 illustrates a preferred embodiment in which a N₂O- and NO_{X}-containing gas stream 205 through a catalyst bed 206 comprising a deN₂O catalyst under suitable conditions to reduce the level of N₂O in the gas stream and thus produce a deN₂O-treated gas stream, which is then used as the NO_{X}-containing gas stream 201, said deN₂O-treated gas stream containing a reduced amount of N₂O. In this embodiment, the additional gas stream 204 comprising NO is provided to either or both of the N₂O- and NO_{X}-containing gas stream 205 and the NO_{X}-containing gas stream 201, such that the ratio of NO₂:NO in the NO_{X}-containing gas stream 201 is no more than 1:1

The invention will now be illustrated by means of the following Examples, which are not intended to limit the invention.

### Examples

The examples were carried out by passing a gas stream containing NOx, N₂O, NH₃, N₂, O₂ and H₂O over a DeNOx catalyst at 250° C. and at different NO/NO₂ ratios. The composition of the gas streams and the results of the tests are shown in Table 1. For the Examples of the invention (2, 4, 6 and 7), extra NO was added to the gas stream in order to correspond to an additional gas stream comprising NO being added to the NO_{X}-containing gas stream in these examples.

The DeNOx catalyst used in the test runs was S-096 catalyst (a vanadium on titania catalyst commercially available from CRI Catalyst Company). A nominal catalyst diameter of 3.2 mm was used in runs 1 to 4 and a nominal catalyst diameter of 1.0 mm was used in runs 5 to 8. The tests showed that, in the examples of the invention (2, 4, 6 and 7), ratios of NO/NO2 above 1:1 (corresponding to an additional gas stream comprising NO being added to the NO_{X}-containing gas stream) result in no increase of the concentration of N₂O over the catalyst being detected. However, for the comparative examples (1, 3, 5 and 8) with lower ratios (corresponding to no additional gas stream comprising NO being added to the NO_{X}-containing gas stream) N₂O concentration was increased over the deNOx catalyst.

TABLE 1

| | | | | | | | | | Outlet data | |
|---|---|---|---|---|---|---|---|---|---|---|
| | Inlet data | | | | | | | | | N₂O |
| | NOx | NO | NO₂ | NO:NO₂ | | | N₂O | | % NOx | Make |
| | ppmv | ppmv | ppmv | ratio | O₂ % | H₂O % | ppmv | ANR* | Conversion | ppmv |
| 1 | 2000 | 400 | 1600 | 0.25:1 | 3 | 2 | 20 | 0.95 | 82.61 | 282.3 |
| 2 | 2000 | 1200 | 800 | 1.5:1 | 3 | 2 | 1000 | 1.05 | 95.69 | 0.0 |
| 3 | 300 | 60 | 240 | 0.25:1 | 10.5 | 2 | 1000 | 0.95 | 60.24 | 30.2 |
| 4 | 300 | 180 | 120 | 1.5:1 | 10.5 | 2 | 20 | 1.05 | 98.54 | 0.0 |
| 5 | 300 | 60 | 240 | 0.25:1 | 3 | 2 | 1000 | 1.05 | 95.43 | 79.0 |
| 6 | 300 | 180 | 120 | 1.5:1 | 3 | 2 | 20 | 0.95 | 93.17 | 0.0 |
| 7 | 2000 | 1200 | 800 | 1.5:1 | 8.5 | 2 | 1000 | 0.95 | 86.08 | 0.0 |
| 8 | 2000 | 400 | 1600 | 0.25:1 | 8.5 | 2 | 20 | 1.05 | 94.12 | 493.4 |

*Ammonia to NOx ratio

1. A process for the treatment of a NO_{X}-containing gas stream, said NO_{X}-containing gas stream containing NO₂ and NO in a molar ratio of NO₂:NO of at least 1:1, to remove at least a portion of the NO_{X} contained therein, said process comprising:
i) providing an additional gas stream comprising NO to the NO_{X}-containing gas stream, such that the molar ratio of NO₂:NO in the NO_{X}-containing gas stream is reduced to be less than 1:1; and
ii) then passing the NO_{X}-containing gas stream through a catalyst bed comprising a deNO_{X} catalyst under suitable conditions to reduce the level of NO_{X} in the gas stream and thus produce a deNO_{X} treated gas stream, said deNO_{X} treated gas stream containing a reduced amount of NO_{X}.

2. The process as claimed in claim 1 wherein the NO_{X}-containing gas stream is derived from the exhaust gas stream from a process for the production of nitric acid.

3. The process for the treatment of a N₂O- and NO_{X}-containing gas stream to remove at least a portion of each of the NO_{X} and the N₂O contained therein, said process comprising:
i) passing the N₂O- and NO_{X}-containing gas stream through a catalyst bed comprising a deN₂O catalyst under suitable conditions to reduce the level of N₂O in said N₂O- and NO_{X}-containing gas stream and thus produce a deN₂O-treated gas stream, said deN₂O-treated gas stream containing a reduced amount of N₂O;
ii) taking at least a portion of said deN₂O-treated gas stream to provide a NO_{X}-containing gas stream;
iii) passing at least a portion of said NO_{X}-containing;
iv) gas stream through a catalyst bed comprising a deNO_{X} catalyst under suitable conditions to reduce the level of NO_{X} in the deN₂O-treated gas stream and thus produce a deNO_{X}-treated gas stream, said deNO_{X}-treated gas stream containing a reduced amount of NO_{X}; and
v) wherein an additional gas stream comprising NO is provided to either or both of the N₂O- and NO_{X}-containing gas stream and the NO_{X}-containing gas stream, such that the ratio of NO₂:NO in the NO_{X}-containing gas stream is less than 1:1.

4. The process as claimed in claim 3, wherein the molar ratio of NO₂:NO in the N₂O- and NO_{X}-containing gas stream, before any introduction of the additional gas stream comprising NO is at least 1:1.

5. The process as claimed in claim 3, wherein the N₂O- and NO_{X}-containing gas stream is derived from the exhaust gas stream from a process for the production of nitric acid.

6. The process as claimed in claim 1, wherein the NO₂ content of the NO_{X}-containing gas stream is in the range of from 500 to 10000 ppmv.

7. The process as claimed in claim 1, wherein the NO content of the NO_{X}-containing gas stream is in the range of from 500 to 10000 ppmv.

8. The process as claimed in claim 3, wherein the N₂O content of the N₂O- and NO_{X}-containing gas stream is in the range of from 500 to 10000 ppmv.

9. The process as claimed in claim 1, wherein the deNO_{X} catalyst comprises a titania carrier and one or more metal compounds which metals are selected from the group consisting of vanadium, molybdenum and tungsten.

10. The process as claimed in claim 2, wherein the NO_{X}-containing gas stream is derived from the exhaust gas stream from a nitric acid plant and the additional gas stream is formed from at least a portion of an outlet stream from the ammonia burner in such a process.

11. The process as claimed in claim, wherein the N₂O and NO_{X}-containing gas stream is derived from the exhaust gas stream from a nitric acid plant and the additional gas stream is formed from at least a portion of an outlet stream from the ammonia burner in such a process.
